(19) United States
(12) Patent Application Publication
(10) Pub. No.: US 2019/0162548 A1
(43) Pub. Date: May 30, 2019

(54) VEHICLE SUPPORT DEVICE, VEHICLE SUPPORT METHOD, AND STORAGE MEDIUM

(71) Applicant: HONDA MOTOR CO., LTD., Tokyo (JP)

(72) Inventor: Takahito Fujita, Wako-shi (JP)

(21) Appl. No.: 16/199,400

(22) Filed: Nov. 26, 2018

(30) Foreign Application Priority Data
Nov. 30, 2017 (JP) 2017-230592

(51) Int. Cl. G01C 21/34; G05B 13/02; B60W 20/12; B60K 6/20

(52) U.S. Cl. CPC G01C 21/3469; G05B 13/0265; B60W 20/12; B60Y 2200/92; B60W 2400/00; B60W 2710/06; B60W 2710/08; B60K 6/20

(57) ABSTRACT

A vehicle support device includes an estimation unit that estimates an energy replenishment point on the basis of the number of times of use or a frequency of use of each energy replenishment point at which a power was stored in a power storage battery of a vehicle in the past, the vehicle including a power generation unit including an internal combustion engine that outputs a motive power to be used by an electric motor, and the electric motor that generates a power using the motive power output, the power storage battery that stores the power generated or a power supplied at the energy replenishment point, an electric motor for traveling that is connected to driving wheels of the vehicle and driven using the power supplied from the power storage battery to rotate the driving wheels, and an information providing unit that provides information on the energy replenishment point.

### CROSS-REFERENCE TO RELATED APPLICATION

Priority is claimed on Japanese Patent Application No. 2017-230592, filed Nov. 30, 2017, the content of which is incorporated herein by reference.

### BACKGROUND OF THE INVENTION

### Field of the Invention

The present invention relates to a vehicle support device, a vehicle support method, and a storage medium.

### Description of Related Art

In the related art, hybrid vehicles in which an internal combustion engine that outputs a motive power for power generation has been mounted have been spreading. In connection therewith, technology for searching for an external charging base at which a subject vehicle can arrive with charging energy of a power storage battery among external charging bases registered by a driver in advance in consideration of a shortest distance of road to be traveled from a position of the subject vehicle to the external charging base, congestion information, or the like using information such as a current position or an altitude of the subject vehicle and information such as positions or altitudes of the external charging bases, and performing power generation so that a power does not fall below a state of charge (SOC) target lower limit value when the vehicle arrives at the external charging base that has been searched for is disclosed (for example, Japanese Unexamined Patent Application, First Publication No. 2010-279108).

### SUMMARY OF THE INVENTION

However, in the related art, in some cases, an energy replenishment point that an occupant does not desire is extracted as a result of the search. Therefore, it is also assumed that the occupant does not move the vehicle to the extracted energy replenishment point. Thus, in the related art, in some cases, it is not possible to acquire the energy replenishment point suitable for the occupant.

An aspect of the present invention has been made in view of such circumstances, and an object thereof is to provide a vehicle support device, a vehicle support method, and a storage medium capable of acquiring an energy replenishment point suitable for an occupant.

A vehicle support device, a vehicle support method, and a storage medium according to the present invention adopt the following configurations.

(1) A vehicle support device including an estimation unit that estimates an energy replenishment point on the basis of the number of times of use or a frequency of use of each energy replenishment point at which a power was stored in a power storage battery of a vehicle in the past, the vehicle including a power generation unit including an internal combustion engine that outputs a motive power to be used by an electric motor, and the electric motor that generates a power using the motive power output by the internal combustion engine, the power storage battery that stores the power generated by the power generation unit or a power supplied at the energy replenishment point, an electric motor for traveling that is connected to driving wheels of the vehicle and driven using the power supplied from the power storage battery to rotate the driving wheels; and an information providing unit that provides information on the energy replenishment point estimated by the estimation unit.

(2) In the aspect (1), the vehicle support device further includes a learning unit that learns the number of times of use or the frequency of use of each energy replenishment point at which the power was stored in the power storage battery in the past, wherein the learning unit learns the number of times of use or the frequency of use for each route from a departure point to an arrival point when the vehicle has used the energy replenishment point.

(3) In the aspect (2), the estimation unit estimates a future traveling route of the vehicle among routes learned by the learning unit on the basis of an environmental situation when the energy replenishment point has been used.

(4) In the aspect (2), the vehicle support device further includes: a specifying unit that specifies an occupant of the vehicle, wherein the learning unit learns the number of times of use or the frequency of use of each energy replenishment point for each occupant specified by the specifying unit.

(5) In the above aspect (4), the estimation unit estimates, for each occupant specified by the specifying unit, an energy replenishment point predicted to be used by the occupant.

(6) In the aspect (1), the estimation unit estimates the energy replenishment point on the basis of the number of times of use or the frequency of use of each energy replenishment point at which the power was stored in the power storage battery in the past in a case that the vehicle is estimated to travel a predetermined distance or more.

(7) A vehicle support method according to an aspect of the present invention is a vehicle control method that is executed by a computer mounted in a vehicle, the vehicle control method including estimating an energy replenishment point on the basis of the number of times of use or a frequency of use of each energy replenishment point at which a power was stored in a power storage battery of a vehicle in the past, the vehicle including a power generation unit including an internal combustion engine that outputs a motive power to be used by an electric motor, and the electric motor that generates a power using the motive power output by the internal combustion engine, the power storage battery that stores the power generated by the power generation unit or a power supplied at the energy replenishment point, an electric motor for traveling that is connected to driving wheels of the vehicle and driven using the power supplied from the power storage battery to rotate the driving wheels; and providing information on the estimated energy replenishment point to the vehicle.

(8) A storage medium according to an aspect of the present invention is a computer-readable non-transitory storage medium storing a program, the program causing a computer to estimate an energy replenishment point on the basis of the number of times of use or a frequency of use of each energy replenishment point at which a power was stored in a power storage battery of a vehicle in the past, the vehicle including a power generation unit including an internal combustion engine that outputs a motive power to be used by an electric motor, and the electric motor that generates a power using the motive power output by the internal combustion engine, the power storage battery that stores the power generated by the power generation unit or a power supplied at the energy replenishment point, an electric motor for traveling that is connected to driving wheels of the vehicle and driven using the power supplied from the power storage battery to rotate the driving wheels; and provide information on the estimated energy replenishment point to the vehicle.

According to the above aspects (1) to (8), it is possible to acquire an energy replenishment point suitable for an occupant.

### BRIEF DESCRIPTION OF THE DRAWINGS

FIG. 1 is a configuration diagram of a vehicle support system according to an embodiment.

FIG. 2 is a diagram showing an example of a configuration of a vehicle in which a vehicle system is mounted.

FIG. 3 is a diagram showing an example of a functional configuration of a plan control unit.

FIG. 4 is a diagram showing an example of content of use history information.

FIG. 5 is a diagram showing an example of content of learning data.

FIG. 6 is a diagram showing a first scheme in an estimation unit.

FIG. 7 is a diagram showing a second scheme in the estimation unit.

FIG. 8 is a diagram showing a third scheme in an estimation unit.

FIG. 9 is a flowchart showing an example of a flow of a learning process that is executed by the vehicle support device.

FIG. 10 is a flowchart showing an example of a flow of a power generation plan providing process that is executed by the vehicle support device.

FIG. 11 is a diagram showing an example of a hardware configuration of the vehicle support device according to an embodiment.

### DETAILED DESCRIPTION OF THE INVENTION

Hereinafter, embodiments of a vehicle support device, a vehicle support method, and a storage medium of the present invention will be described with reference to the drawings.

[Overall Configuration]

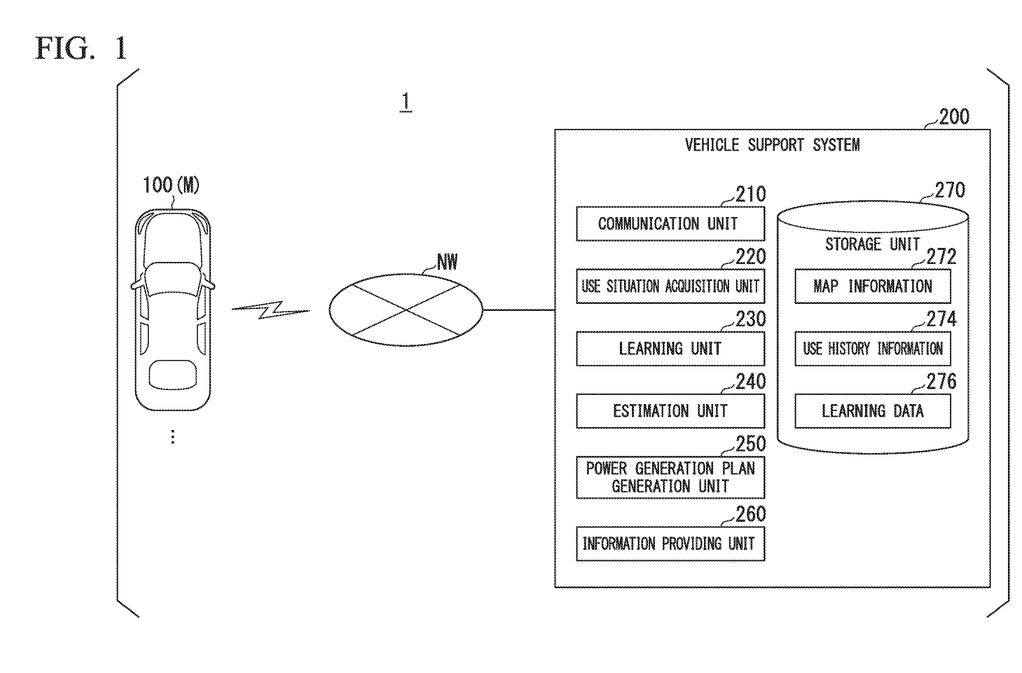

FIG. 1 is a configuration diagram of a vehicle support system 1 according to the embodiment. The vehicle support system 1 includes one or more vehicles 100 and a vehicle support device 200. These components can communicate with each other via a network NW. The network NW includes the Internet, a wide area network (WAN), a local area network (LAN), a public line, a provider device, a dedicated line, a radio base station, and the like.

[Vehicle]

The vehicle 100 is, for example, a vehicle such as a two-wheeled vehicle, a three-wheeled vehicle, or a four-wheeled vehicle. A drive source of the vehicle 100 is an internal combustion engine such as a diesel engine or a gasoline engine, an electric motor, or a combination thereof. When the electric motor is included, the electric motor operates using a power generated by the electric motor connected to the internal combustion engine, or a discharge power of a secondary battery or a fuel cell. Hereinafter, a hybrid vehicle adopting a series scheme will be described by way of example. The series scheme is a scheme in which an engine is not mechanically connected to driving wheels, a motive power of the engine is used for power generation in an electric motor, and a generated power is supplied to an electric motor for traveling. This vehicle may be a vehicle of which a battery can be charged through plug-in. Hereinafter, a vehicle distinguished from other vehicles in description among one or more vehicles 100 included in the vehicle support system 1 will be referred to as a “subject vehicle M”.

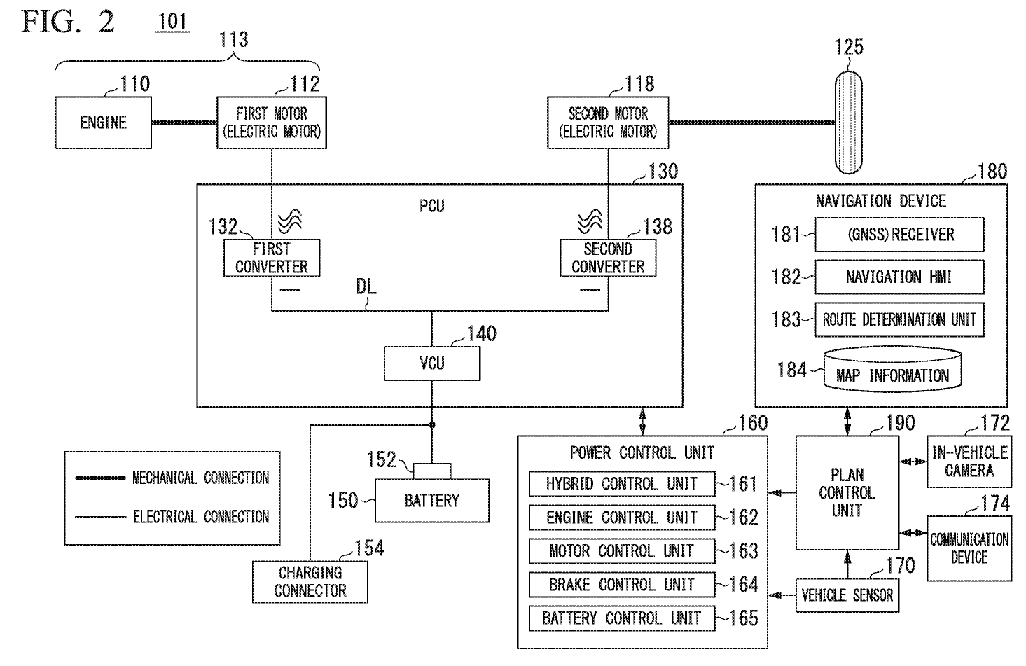

FIG. 2 is a diagram showing an example of a configuration of the vehicle 100 in which the vehicle system 101 is mounted. For example, an engine 110, a first motor (an electric motor) 112, a second motor (an electric motor) 118, a driving wheel 125, a power control unit (PCU) 130, a battery (a power storage battery) 150, a motive power control unit 160, a vehicle sensor 170, an in-vehicle camera 172, a communication device 174, a navigation device 180, and a plan control unit 190.

The engine 110 is an internal combustion engine that outputs motive power by burning fuel such as gasoline. The engine 110 is, for example, a reciprocating engine including a cylinder and a piston, an intake valve, an exhaust valve, a fuel injection device, a spark plug, a connection rod, a crankshaft, and the like. Any engine, such as a diesel engine, a gas turbine engine, a rotary engine, or an external combustion engine, may be used as the engine 110 as long as the engine generates motive power. A motive power that can be output by the engine 110 is a motive power lower than a motive power that is required for generation of the amount of power for the first motor 112 driving a second motor 118 in real time (or the amount of power capable of causing the vehicle 100 to travel at a predetermined speed or more). Since the engine 110 is small in size and light in weight, the engine 110 has an advantage that a degree of freedom in layout of the vehicle 100 can be increased.

The first motor 112 is, for example, a three-phase alternating current (AC) electric motor. The first motor 112 is mainly used for power generation. The first motor 112 includes a rotor connected to an output shaft (for example, a crankshaft) of the engine 110 and generates power using the motive power output by the engine 110. An example of the power generation unit 113 is a combination of the engine 110 and the first motor 112.

The second motor 118 is an electric motor for traveling that rotates the driving wheel 125. The second motor 118 is, for example, a three-phase AC electric motor. The second motor 118 drives and regenerates the vehicle 100. A rotor of the second motor 118 is connected to the driving wheel 125. The second motor 118 outputs a motive power to the driving wheel 125 using the power supplied from the battery 150. The second motor 118 generates power using a kinetic energy of the vehicle 100 at the time of deceleration of the vehicle 100. Hereinafter, a power generation operation of the second motor 118 may be referred to as regeneration.

The PCU 130 includes, for example, a first converter 132, a second converter 138, and a voltage control unit (VCU) 140. A configuration in which these components are formed as the PCU 130 which is a single unit is merely an example, and these components may be arranged in a distributed manner.

The first converter 132 and the second converter 138 are, for example, AC-DC converters. DC side terminals of the first converter 132 and the second converter 138 are connected to a DC link DL. The battery 150 is connected to the DC link DL via a VCU 140. The first converter 132 converts an alternating current generated by the first motor 112 into a direct current and outputs the direct current to the direct current link DL or converts a direct current supplied via the direct current link DL into an alternating current and supplies the alternating current to the first motor 112. Similarly, the second converter 138 converts an alternating current generated by the second motor 118 into a direct current and outputs the direct current to the direct current link DL or converts the direct current supplied via the direct current link DL into an alternating current and supplies the alternating current to the second motor 118.

The VCU 140 is, for example, a DC-DC converter. The VCU 140 boosts a power supplied from the battery 150 and outputs the boosted power to the DC link DL.

The battery 150 is, for example, a secondary battery such as a lithium ion battery. The battery 150 stores, for example, power generated by the power generation unit (the engine 110 and the first motor 112). The battery 150 may store regenerative power from the second motor 118.

The charging connector 154 is a connector configured to be detachably connected to a charging plug of a charging facility so as to acquire power supplied from a charging facility or the like installed at an energy replenishment point. A charging stand that charges the power storage battery of the vehicle M, a gasoline stand that supplies fuel such as gasoline, or the like is installed at the energy replenishment point.

The motive power control unit 160 includes, for example, a hybrid control unit 161, an engine control unit 162, a motor control unit 163, a brake control unit 164, and a battery control unit 165. The hybrid control unit 161 outputs instructions to the engine control unit 162, the motor control unit 163, the brake control unit 164, and the battery control unit 165. The instructions of the hybrid control unit 161 will be described below.

According to the instruction from the hybrid control unit 161, the engine control unit 162 performs ignition control of the engine 110, throttle opening degree control, fuel injection control, fuel cut control, and the like. The engine control unit 162 may calculate an engine speed on the basis of the output of a crank angle sensor attached to a crankshaft and output the engine speed to the hybrid control unit 161.

The motor control unit 163 performs control of switching between the first converter 132 and/or the second converter 138 according to the instruction from the hybrid control unit 161.

The brake control unit 164 controls a brake device (not illustrated) according to the instruction from the hybrid control unit 161. The brake device is a device that outputs a brake torque according to a braking operation of a driver to each wheel.

The battery control unit 165 calculates the amount of power (for example, a state of charge; a charge rate) of the battery 150 on the basis of an output of a battery sensor 152 attached to the battery 150 and outputs the amount of power to the hybrid control unit 161.

The vehicle sensor 170 includes, for example, an accelerator opening degree sensor, a vehicle speed sensor, a brake pedal depression amount sensor, and a direction sensor. The accelerator opening degree sensor is attached to an accelerator pedal which is an example of an operator which receives an acceleration instruction from the driver, detects the amount of operation of the accelerator pedal, and outputs the amount of operation to the motive power control unit 160 as a degree of accelerator opening. The vehicle speed sensor includes, for example, wheel speed sensors attached to respective wheels, and a speed calculator, integrates wheel speeds detected by the wheel speed sensors to derive a speed (a vehicle speed) of the vehicle 100, and outputs the speed to the motive power control unit 160. The brake pedal depression amount sensor is attached to a brake pedal which is an example of an operator that receives a deceleration or stop instruction from the driver, detects the amount of operation of the brake pedal, and outputs the amount of operation as the amount of brake pedal to the motive power control unit 160. The direction sensor detects a direction (a progressing direction) of the vehicle 100 and outputs a result of the detection to the plan control unit 190.

The in-vehicle camera 172 mainly images, for example, a face of an occupant seated on a seat installed in the vehicle cabin (in particular, an occupant seated in a driver seat). The in-vehicle camera 172 is, for example, a digital camera using a solid-state imaging element such as a charge coupled device (CCD) or a complementary metal oxide semiconductor (CMOS). The in-vehicle camera 172 images, for example, the occupant at a predetermined timing. The predetermined timing is, for example, a timing when a load equal to or greater than a predetermined value has been detected by a load sensor provided in the seat, a timing when a power of the vehicle 100 is controlled to be turned on (a timing when a power of the battery 150 is supplied to each unit of the vehicle and the vehicle is controlled to enter a travelable state), a timing when a predetermined switch operation of an occupant has been received, and the like. A captured image of the in-vehicle camera 172 is output to the plan control unit 190. An image captured by the in-vehicle camera 172 is used, for example, to identify an occupant.

The communication device 174 communicates with other vehicles existing around the subject vehicle M using a cellular network, a Wi-Fi network, Bluetooth (registered trademark), dedicated short range communication (DSRC), or the like, and communicates with the vehicle support device 200 via a wireless base station.

The navigation device 180 includes, for example, a global navigation satellite system (GNSS) receiver 181, a navigation HMI 182, and a route determination unit 183 and holds map information 184 in a storage device such as a hard disk drive (HDD) or a flash memory. The GNSS receiver 181 specifies a position of the vehicle 100 on the basis of a signal received from a GNSS satellite. The position of the vehicle 100 may be specified or supplemented by an inertial navigation system (INS) using an output of the vehicle sensor 170. The navigation HMI 182 includes a display device, a speaker, a touch panel, keys, and the like. The route determination unit 183 determines, for example, a route to a destination input by the occupant using the navigation HMI 182 (hereinafter referred to as an “on-map route”) by referring to the map information 184 from the position of the vehicle 100 specified by the GNSS receiver 181 or an arbitrary input position (hereinafter referred to as a departure point). The route determination unit 183 may also generate a travel plan including, for example, a time at which the vehicle is scheduled to travel on a road included in the route. The travel plan is a plan additionally including a time at which a user desires to arrive at a destination, congestion information on roads, a route through which the user desires to pass, a type of road through which the user desires to pass, and the like. The travel plan is displayed on, for example, the navigation HMI 182. The occupant controls the vehicle 100 so that the occupant can arrive at the destination at a desired arrival time according to the travel plan displayed on the navigation HMI 182. The vehicle 100 according to the embodiment may be an automatically driven vehicle that automatically controls steering and an acceleration and deceleration of the vehicle 100 on the basis of the travel plan and a surrounding situation of the vehicle 100. The on-map route or the travel plan determined by the route determination unit 183 is output to the plan control unit 190. The map information 184 is, for example, information in which a road shape is expressed by a link indicating a road and nodes connected by the link. The map information 184 may include a curvature of a road, point of interest (POI) information, and the like. Position information of energy replenishment points and energy replenishment point IDs which are identification information of the energy replenishment points are included in the map information 184.

Control of the hybrid control unit 161 will be described herein. The hybrid control unit 161 derives, first, a required driving shaft torque Td on the basis of the degree of accelerator opening and a target vehicle speed and determines a required driving shaft power Pd that is output from the second motor 118. The hybrid control unit 161 determines whether or not the engine 110 is to be operated on the basis of the determined required driving shaft power Pd, power consumption of an auxiliary device, the amount of power of the battery 150, or the like, and determines an engine power Pe to be output from the engine 110 when the hybrid control unit 161 has determined that the engine 110 is to be operated.

The hybrid control unit 161 determines a reaction torque of the first motor 112 according to the determined engine power Pe so that the reaction torque is balanced with the engine power Pe. The hybrid control unit 161 outputs the determined information to the engine control unit 162. When a brake is operated by an occupant (a driver), the hybrid control unit 161 determines a distribution of a brake torque that can be output due to regeneration of the second motor 118 and a brake torque to be output by the brake device and outputs the distribution to the motor control unit 163 and the brake control unit 164.

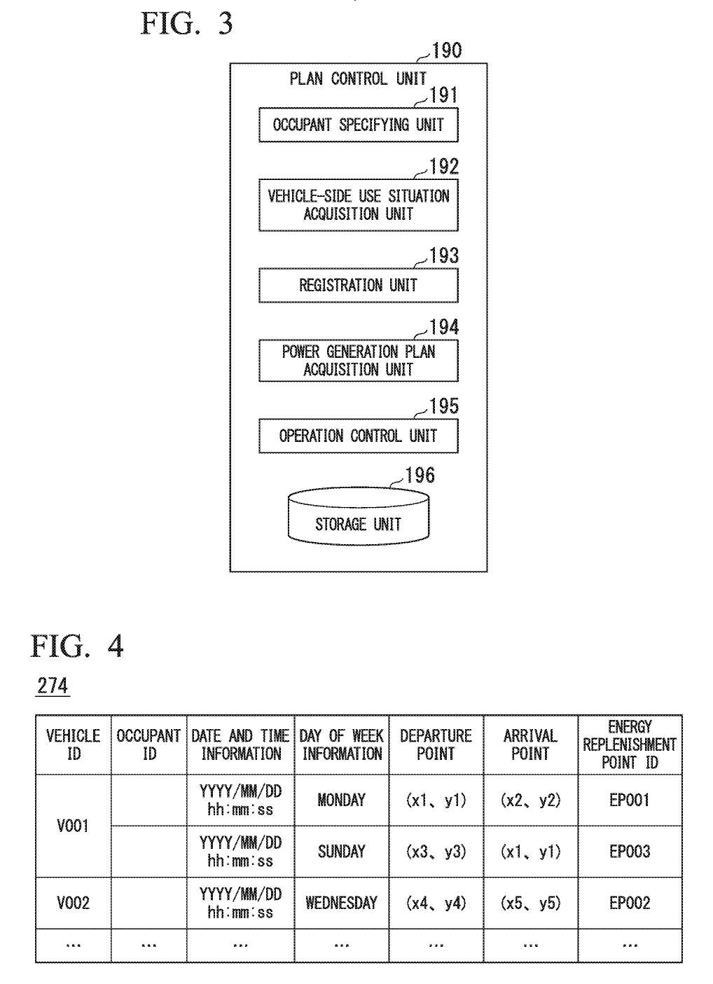

The plan control unit 190 controls an operation of the power generation unit on the basis of, for example, information acquired from the vehicle support device 200 with respect to the vehicle 100 that travels along a route from a departure point to a destination. FIG. 3 is a diagram showing an example of a functional configuration of the plan control unit 190. The plan control unit 190 includes, for example, an occupant specifying unit (an example of a specifying unit) 191, a vehicle-side use situation acquisition unit 192, a registration unit 193, a power generation plan acquisition unit 194, an operation control unit 195, and a storage unit 196. For example, the occupant specifying unit 191, the vehicle-side use situation acquisition unit 192, the registration unit 193, the power generation plan acquisition unit 194, and the operation control unit is realized by, for example, a hardware processor such as a central processing unit (CPU) executing a program (software). Some or all of these components may be realized by hardware (including a circuit unit or a circuitry) such as a large scale integration (LSI), an application specific integrated circuit (ASIC), a field-programmable gate array (FPGA), or a graphics processing unit (GPU) or may be realized by cooperation of software and hardware.

The occupant specifying unit 191 specifies an occupant who drives the vehicle 100. For example, the occupant specifying unit 191 analyzes the captured image of the in-vehicle camera 172, performs a face authentication process, and specifies an occupant. Specifically, the occupant specifying unit 191 acquires facial feature information through the face authentication process, collates the acquired facial feature information with feature information of a face of each person stored in the storage unit 196 in advance, and specifies a person with a face with a highest degree of similarity to an occupant that has boarded the vehicle. The occupant specifying unit 191 acquires an identification ID associated with the person specified as the occupant as an occupant ID. When the degree of similarity with the person is equal to or lower than a threshold value as a result of the collation, the occupant specifying unit 191 may notify the occupant of information indicating that the degree of similarity with the person is equal to or lower than the threshold value, perform a process of registering the face of occupant, and then perform the occupant specifying process again.

The process of the occupant specifying unit 191 is executed, for example, at a timing when a load equal to or greater than a predetermined value is applied to the driver seat of the vehicle 100. The process of the occupant specifying unit 191 may be performed at a timing when the power of the vehicle 100 is controlled to enter an ON state or may be performed at a timing when the occupant has operated a predetermined switch in the vehicle 100. By specifying the occupant using the occupant specifying unit 191, it is possible to manage a use situation for each occupant or acquire energy replenishment points suitable for occupants, for example, when the same vehicle is used by another family member or when a vehicle is shared with other persons.

The vehicle-side use situation acquisition unit 192 acquires information on the use situation of the facility at the energy replenishment point of the vehicle 100. For example, the vehicle-side use situation acquisition unit 192 acquires information such as a route on which the vehicle 100 has actually traveled, a departure point, an arrival point, a used energy replenishment point. The vehicle-side use situation acquisition unit 192 may acquire information on the route from the departure point to the destination determined by the route determination unit 183. For example, the vehicle-side use situation acquisition unit 192 acquires position information of the vehicle 100 at predetermined time intervals and acquires information on the route from the acquired position information. The vehicle-side use situation acquisition unit 192 acquires, for example, a point at which the power of the vehicle 100 is controlled to be ON as the departure point. The vehicle-side use situation acquisition unit 192 acquires, as the arrival point, a point at which the power of the vehicle 100 is controlled to enter the OFF state. The vehicle-side use situation acquisition unit 192 may acquire information on the route, the departure point, the arrival point, and the used energy replenishment point from information set by the navigation device 180.

For example, when the charging connector 154 is connected to the charging facility and a predetermined amount of power or more is supplied to the battery 150, the vehicle-side use situation acquisition unit 192 sets a point at which the power is supplied as the used energy replenishment point and acquires the energy replenishment point ID associated with the energy replenishment point. The vehicle-side use situation acquisition unit 192 may acquire the used energy replenishment point through, for example, a predetermined switch operation of the occupant and acquire the energy replenishment point ID associated with the energy replenishment point.

The registration unit 193 associates the information on the use situation acquired by the vehicle-side use situation acquisition unit 192 with the vehicle ID and the occupant ID, transmits the information to the vehicle support device 200 via the communication device 174, and performs registration of the use situation. The information on the use situation corresponds to use history information (see FIG. 4) to be described below.

The power generation plan acquisition unit 194 acquires information on the current position information and the current progressing direction of the vehicle 100 and transmits an acquisition request of the power generation plan in which the acquired information on the position information and the progressing direction is associated with the vehicle ID and the occupant ID, to the vehicle support device 200. The power generation plan is, for example, a plan in which a timing when the power generation unit 113 is operated or the amount of generated power per time output by the power generation unit 113 is defined, which is a plan for charging the battery 150 with the power generated by the power generation unit 113 or a plan for supplying a power to the second motor 118.

The power generation plan acquisition unit 194 transmits, for example, an acquisition request for a power generation plan to the vehicle support device 200 at a timing when the vehicle 100 has started traveling or at a timing when a predetermined time has elapsed from the traveling. The power generation plan acquisition unit 194 may transmit the acquisition request for a power generation plan to the vehicle support device 200 at a timing when a predetermined switch operation of the occupant is received. The power generation plan acquisition unit 194 acquires information on the power generation plan generated by the vehicle support device 200.

The operation control unit 195 controls an operation of the power generation unit 113 on the basis of the power generation plan from the vehicle support device 200 acquired by the power generation plan acquisition unit 194.

The storage unit 196 is realized by a hard disk drive (HDD), a flash memory, a random access memory (RAM), a read only memory (ROM), or the like. The storage unit 196 stores, for example, face authentication information and other information.

[Vehicle Support Device]

Returning to the description of FIG. 1, the vehicle support device 200 includes, for example, a communication unit 210, a use situation acquisition unit 220, a learning unit 230, an estimation unit 240, a power generation plan generation unit 250, an information providing unit 260, and a storage unit 270. The use situation acquisition unit 220, the learning unit 230, the estimation unit 240, the power generation plan generation unit 250, and the information providing unit 260 are realized by, for example, a hardware processor such as a CPU executing a program (software). Some or all of these components may be realized by hardware (including a circuit unit or a circuitry) such as LSI, an ASIC, an FPGA, or a GPU, or may be realized by cooperation of software and hardware.

The storage unit 270 is realized by an HDD, a flash memory, a RAM, a ROM, or the like. The storage unit 270 stores, for example, map information 272, use history information 274, learning data 276, and other information. Road information, traffic regulation information, address information (an address and a postal code), and facility information for respective roads indicated by nodes and links, for example, are included in the map information 272. Information such as a road ID which is identification information of a road, information indicating a type of road such as an expressway, a toll road, a national highway, or a prefectural road, the number of lanes of the road, an area of an emergency parking zone, a width of each lane, a gradient of the road, a position of the road (three-dimensional coordinates including longitude, latitude, and height), a curvature of a curve of the lane, positions of merging and branching points of the lane, and signs provided on the road are included in the map information 272. Position information of energy replenishment points and energy replenishment point IDs which are identification information of the energy replenishment points are included in the map information 184. The map information 272 may be updated at any time through access to another device using the communication unit 210.

The communication unit 210 is, for example, a network card for connection to the network NW. The communication unit 210 communicates with the vehicle 100 via the network NW.

The use situation acquisition unit 220 acquires the vehicle ID, the occupant ID, and the information on the use situation of the facility at the energy replenishment point and stores the acquired information in the storage unit 270 as use history information 274. FIG. 4 is a diagram showing an example of content of the use history information 274. The use history information 274 is, for example, information in which date and time information, day of week information, a departure point, an arrival point, and an energy replenishment point ID are associated with a vehicle ID that is identification information of the vehicle and an occupant ID that is identification information of the occupant. The date and time information may be, for example, a date and time when the vehicle has departed from the departure point, or a date and time when the vehicle has arrived at the energy replenishment point. The day of week information is information on a day of a week corresponding to a date of the date and time information. The departure point and the arrival point are position information (for example, latitude and longitude) of the departure point and the arrival point when the vehicle 100 uses the energy replenishment point. The departure point is, for example, a point at which the vehicle is located at a timing when the power of the vehicle 100 is controlled to enter an ON state. The arrival point is a point at which the vehicle 100 is located at a timing when the power of the vehicle 100 is controlled to enter an OFF state. The arrival point may be a point at which the vehicle 100 is replenished with energy or may be a point at which the vehicle 100 has stopped for a predetermined time or more without being replenished with energy.

The learning unit 230 aggregates the energy replenishment points for each vehicle ID or for each occupant ID on the basis of the use history information 274 stored in the storage unit 270 and acquires one or both of the number of times of use and the frequency of use of the facility at the energy replenishment point. The number of times of use is, for example, the number of times of past use of each energy replenishment point ID associated with the vehicle ID and the occupant ID. The frequency of use is, for example, a value obtained by dividing the number of times of use of each energy replenishment point used for each occupant ID by a total number of times of use of all the energy replenishment points used for the occupant ID.

The learning unit 230 may acquire one or both of the number of times of use or the frequency of use in each predetermined period of time. Thus, for example, by acquiring the number of times of use or the frequency of use in a period of time from a present time to three months ago, it is possible to acquire, for example, energy replenishment points which have recently started to be used for each vehicle or for each occupant.

The learning unit 230 may learn the number of times of use or the frequency of use for each route from the departure point to the arrival point when the vehicle 100 uses the facilities at the energy replenishment points. The route may be divided into an outward route and a return route on the same route. The learning unit 230 may learn the number of times of use or the frequency of use on the basis of an environmental situation when facilities at energy replenishment points have been used. The environmental situation is, for example, day of week information or time zone information when the vehicle 100 travels. The environmental condition may be weather information, congestion information, or the like when the vehicle 100 is traveling. Accordingly, it is possible to statistically learn one or both of the number of times of use and frequency of use under more detailed conditions.

The learning unit 230, for example, may vectorize the vehicle ID of the vehicle 100, the occupant ID, the current position of the vehicle 100, and the progressing direction of the vehicle 100 and perform machine learning on a plurality of vectors obtained by the vectorization to generate a learning model. When the vehicle ID, the occupant ID, the current position, and the progressing direction are input to the learning model (learning data), an energy replenishment point corresponding to the input information is output.

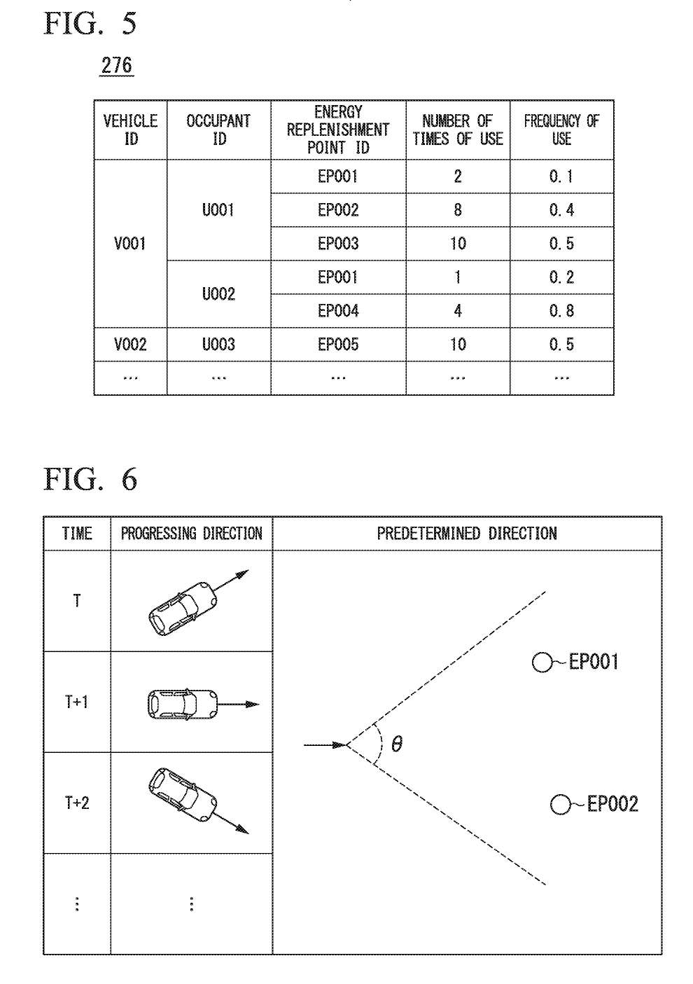

The learning unit 230 stores a learning result as the learning data 276 in the storage unit 270. FIG. 5 is a diagram showing an example of content of the learning data 276. The learning data 276 is, for example, information in which the number of times of use and the frequency of use are associated with the vehicle ID, the occupant ID, and the energy replenishment point ID. The learning data 276 may be data in which the number of times of use and the frequency of use are divided for each environmental situation in addition to content of the vehicle ID, the occupant ID, and the energy replenishment point ID illustrated in FIG. 5.

The estimation unit 240 estimates the energy replenishment point that is expected to be used by the vehicle 100 in the future on the basis of the acquisition request for a power generation plan transmitted by the vehicle 100 and the use history information 274 and the learning data 276 stored in the storage unit 270. The estimation unit 240 estimates, for example, the energy replenishment points using at least one of the following schemes.

<First Scheme>

In a first scheme, the estimation unit 240 estimates energy replenishment points on the basis of a current position and a progressing direction of the vehicle 100. FIG. 6 is a diagram showing the first scheme in the estimation unit 240. In the first scheme, for example, the estimation unit 240 acquires the current position and the progressing direction from the vehicle 100 at time T and acquires energy replenishment points present in a predetermined direction (for example, within a range of an angle θ) with reference to the current position and the progressing direction that have been acquired as candidates for energy replenishment points to be used by the vehicle 100. In the example of FIG. 6, energy replenishment points EP001 and EP002 are acquired as candidates. When progressing directions of the vehicle 100 at each of times T, T+1, T+2, . . . are acquired, the estimation unit 240 may acquire energy replenishment points present in a predetermined direction with reference to a direction obtained by combining the respective progressing directions.

Then, the estimation unit 240 collates the vehicle ID, the occupant ID, and the energy replenishment point ID of the learning data 276 on the basis of the vehicle ID, the occupant ID, and the acquired energy replenishment point and estimates an energy replenishment point with the largest number of times of use or the highest frequency of use as the energy replenishment point to be used by the vehicle 100 in the future. For example, when the vehicle ID is V001 and the occupant ID is U001, the frequency of use of the energy replenishment point EP002 is larger than that of EP001. Therefore, the estimation unit 240 estimates the energy replenishment point EP002 as the energy replenishment point to be used by the vehicle 100 in the future.

<Second Scheme>

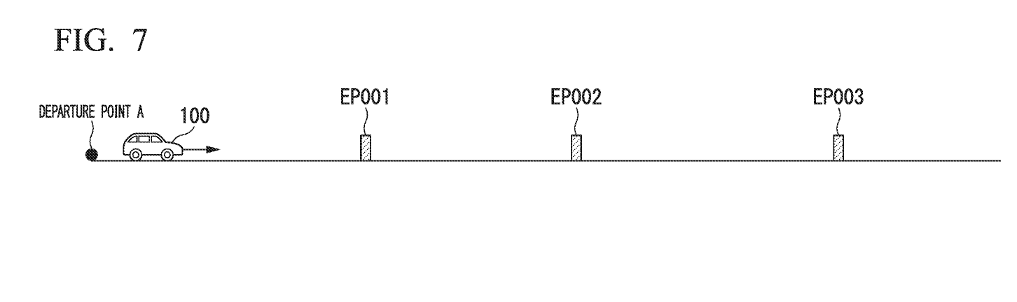

In a second scheme, the estimation unit 240 estimates energy replenishment points on the basis of a route on which the vehicle 100 is currently traveling. FIG. 7 is a diagram showing the second scheme in the estimation unit 240. In the example of FIG. 7, a departure point A of vehicle 100 and energy replenishment points EP001 to EP003 are shown. In the second scheme, the estimation unit 240 estimates a route on which the vehicle 100 is traveling by referring to the map information 272 on the basis of the position information of the vehicle 100 at predetermined time intervals. The estimation unit 240 acquires candidates for energy replenishment points closer to the estimated route. “Close to the route” means, for example, a range in which the shortest distance from the route is within a predetermined distance (for example, within 100 m). In the example of FIG. 7, EP001 to EP003 are acquired as the energy replenishment points close to the route.

Then, the estimation unit 240 collates the vehicle ID, the occupant ID, and the energy replenishment point ID of the learning data 276 on the basis of the vehicle ID, the occupant ID, and the acquired energy replenishment point and estimates an energy replenishment point with the largest number of times of use or the highest frequency of use as the energy replenishment point to be used by the vehicle 100 in the future. For example, when the vehicle ID is V001 and the occupant ID is U001, the number of times of use of the energy replenishment point EP003 is larger than that of the other energy replenishment points. Therefore, the estimation unit 240 estimates the energy replenishment point EP003 as the energy replenishment point to be used by the vehicle 100 in the future.

<Third Scheme>

For example, it is predicted that arrival points differ even though routes to a midway point are the same between a route on Monday to Friday and a route on Sunday. It is predicted that arrival points differ even though routes to a midway point are the same between traveling in the morning and traveling in the afternoon. Therefore, according to a third scheme, the estimation unit 240 estimates the energy replenishment point on the basis of an environmental situation at the time of traveling of the vehicle 100.

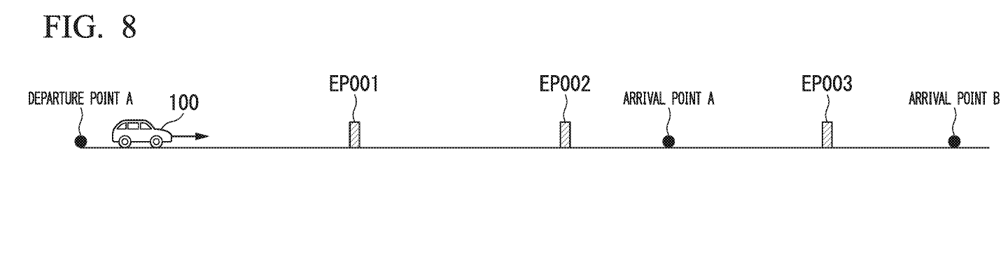

FIG. 8 is a diagram showing the third scheme in the estimation unit 240. In the example of FIG. 8, the departure point A of the vehicle 100, the energy replenishment points EP001 to EP003 used in the past in a case in which the vehicle ID is V001 and the occupant ID is U001, and past arrival points A and B are shown. In the third scheme, the estimation unit 240 collates the vehicle ID of the vehicle 100, the occupant ID, and a day of the week when the acquisition request of the power generation plan has been received with the vehicle ID, the occupant ID, and day of week information of the use history information 274 to estimate an arrival point at which the vehicle 100 is estimated to travel in the future and a candidate for the energy replenishment point.

Here, it is assumed that the occupant of the vehicle 100 causes the vehicle 100 to travel to the arrival point A in the case of a weekday (Monday to Friday) and causes the vehicle 100 to travel to the arrival point B in the case of a weekend day (Saturday and Sunday). In this case, when a day of the week at the time of reception of the acquisition request for a power generation plan from the vehicle 100 is any of Monday to Friday, the estimation unit 240 estimates that the vehicle 100 is traveling toward the arrival point A from the use history information 274 and acquires the energy replenishment points EP001 and EP002 present near the route to the arrival point A. Then, the estimation unit 240 collates the vehicle ID, the occupant ID, and the energy replenishment point ID of the learning data 276 on the basis of the vehicle ID, the occupant ID, and the acquired energy replenishment point and estimates an energy replenishment point with the largest number of times of use or the highest frequency of use as the energy replenishment point to be used by the vehicle 100 in the future. For example, when the vehicle ID is V001 and the occupant ID is U001, the number of times of use of the energy replenishment point EP002 is larger than that of EP001. Therefore, the estimation unit 240 estimates the energy replenishment point EP002 as the energy replenishment point to be used by the vehicle 100 in the future.

When the day of the week at the time of reception of the acquisition request for a power generation plan from the vehicle 100 is Saturday or Sunday, the estimation unit 240 estimates that the vehicle 100 is traveling toward the arrival point B from the use history information 274 and acquires the energy replenishment points EP001 to EP003 present near the route to the arrival point B. Then, the estimation unit 240 collates the vehicle ID, the occupant ID, and the energy replenishment point ID of the learning data 276 on the basis of the vehicle ID, the occupant ID, and the acquired energy replenishment point and estimates an energy replenishment point with the largest number of times of use or the highest frequency of use as the energy replenishment point to be used by the vehicle 100 in the future. For example, when the vehicle ID is V001 and the occupant ID is U001, the number of times of use of the energy replenishment point EP003 is larger than that of the other energy replenishment points. Therefore, the estimation unit 240 estimates the energy replenishment point EP003 as the energy replenishment point to be used by the vehicle 100 in the future.

Thus, by estimating the energy replenishment point, it is possible to acquire an energy replenishment point suitable for the occupant and to generate a more appropriate charging plan in order to replenish the energy at the acquired energy replenishment point.

The estimation unit 240 may estimate, for each occupant, an energy replenishment point predicted to be used by an occupant. The energy replenishment point predicted to be used by the occupant is, for example, an energy replenishment point at which the number of times of use or the frequency of use of the occupant is equal to or greater than a predetermined value. The energy replenishment point predicted to be used by the occupant is an energy replenishment point of the same affiliate. The same affiliate is, for example, the same company or a related company. Accordingly, it is possible to estimate the energy replenishment point highly likely to be used by the occupant among the plurality of energy replenishment points.

The estimation unit 240 determines whether or not the vehicle 100 travels a predetermined distance or more. When the estimation unit 240 has determined that the vehicle 100 travels the predetermined distance or more, the estimation unit 240 may estimate the energy replenishment point on the basis of one or both of the number of times of use and the frequency of use. Accordingly, when it is predicted that the vehicle 100 travels a long distance, the estimation unit 240 estimates the energy replenishment point. When the distance to the destination is short and energy replenishment is not required, execution of the process of estimating the energy replenishment point can be suppressed.

The estimation unit 240 may input information obtained by vectorizing the vehicle ID, the occupant ID, the current position, and the progressing direction of the vehicle 100 to the learning data generated by the learning unit 230 and acquires the energy replenishment point.

The power generation plan generation unit 250 generates a power generation plan to replenish energy at the energy replenishment point estimated by the estimation unit 240. For example, in order for the vehicle to use a facility at the energy replenishment point estimated by the estimation unit 240, the power generation plan generation unit 250 generates a power generation plan so that the SOC of the battery of the vehicle 100 is not equal to or smaller than a lower limit threshold value at a distance or on a route until the vehicle arrives at the energy replenishment point.

The information providing unit 260 provides information on the energy replenishment point estimated by the estimation unit 240 to the vehicle 100. For example, the information providing unit 260 provides information on the power generation plan generated by the power generation plan generation unit 250 to the vehicle 100.

[Process Flow]

Next, a flowchart showing an example of a flow of a process that is executed by the vehicle support device 200 will be described. The process of the vehicle support device 200 is roughly divided into a learning process for learning a use situation of facilities at energy replenishment points of the vehicle 100 and a process of providing a power generation plan of the vehicle 100. Hereinafter, each process flow will be described.

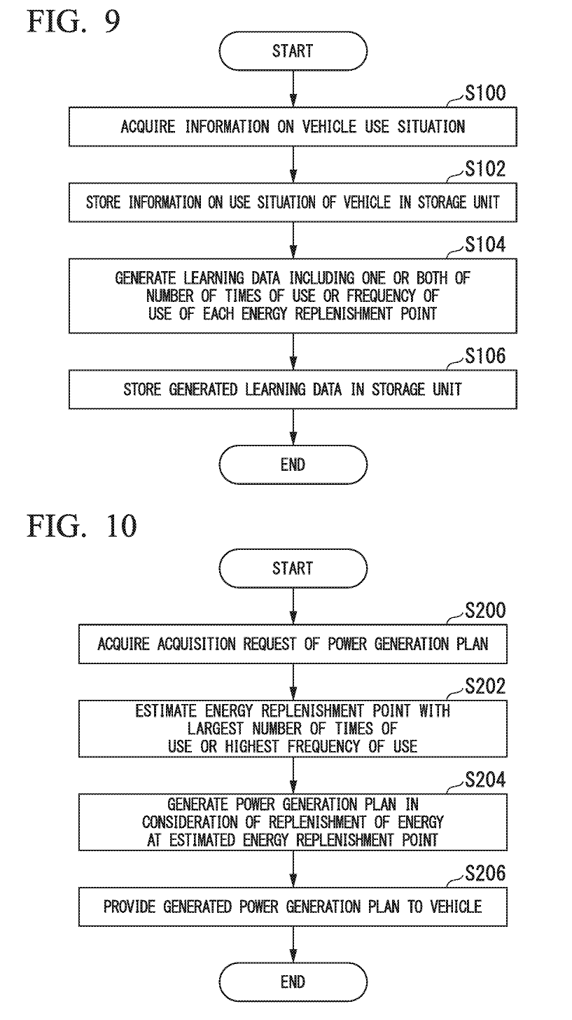

FIG. 9 is a flowchart showing an example of a flow of a learning process that is executed by the vehicle support device 200. In the example of FIG. 9, the use situation acquisition unit 220 acquires information on a vehicle use situation such as a vehicle ID, an occupant ID, a departure point, an arrival point, or an energy replenishment point from the vehicle 100 (step S100). The use situation acquisition unit 220 stores the information on the use situation of the vehicle acquired from the vehicle 100 as the use history information 274 in the storage unit 270 (step S102).

Then, the learning unit 230 performs an aggregation process on the information stored in the use history information 274 for each vehicle ID or occupant ID, associates a result of the aggregation with the vehicle ID and the occupant ID, generates learning data 276 including one or both of the number of times of use or a frequency of use of each energy replenishment point (step S104), and stores the generated learning data 276 in the storage unit 270 (step S106). Accordingly, this flowchart ends. In the process illustrated in FIG. 9, the processes of steps S100 to S102 and the processes of steps S104 to S106 may be performed asynchronously. The vehicle support device 200 performs the processes of steps S100 to S102 at a timing when the use situation has been acquired from the vehicle 100 and performs the processes of steps S104 to S106 each time a predetermined time elapses or at a timing when there is an instruction from a manager or the like of the vehicle support device 200.

FIG. 10 is a flowchart showing an example of a flow of a power generation plan providing process that is executed by the vehicle support device 200. In the example of FIG. 10, the estimation unit 240 acquires an acquisition request of the power generation plan from the vehicle 100 (step S200), and the estimation unit 240 estimates an energy replenishment point with the largest number of times of use or the highest frequency of use on the basis of the acquired acquisition request (step S202). Then, the estimation unit 240 generates a power generation plan in consideration of replenishment of energy at the estimated energy replenishment point (step S204). Then, the information providing unit 260 provides the generated power generation plan to the vehicle 100 (step S206). Accordingly, the process of this flowchart ends.

According to the embodiment described above, the vehicle support device includes the estimation unit 240 that estimates the energy replenishment point on the basis of the number of times of use or the frequency of use of each energy replenishment point at which power was stored in the past in the power storage battery of the vehicle including the engine (an internal combustion engine) 110 that outputs a motive power to be used by the electric motor, the power generation unit 113 including the electric motor that generates power using the motive power output by the engine 110, the battery (power storage battery) 150 that stores the power generated by the power generation unit 113 or power supplied at the energy replenishment point, and the second motor (an electric motor for traveling) 118 that is connected to driving wheels of the vehicle and driven using the power supplied from the battery to rotate the driving wheels, and the information providing unit 260 that provides information on the energy replenishment point estimated by the estimation unit 240. Thus, it is possible to acquire the energy replenishment point suitable for occupants. According to the embodiment, it is possible to realize appropriate energy management control in which it is assumed that energy replenishment is performed at the acquired energy replenishment point.

In the embodiment, various functions of the vehicle support device 200 may be provided in the plan control unit 190 of the vehicle 100. In this case, information including the use history information 274 and the learning data 276 is stored in the storage unit 196. Since only information on the subject vehicle M is stored in the use history information 274 and the learning data 276, information on the vehicle ID is not included in the use history information 274 and the learning data 276.

[Hardware Configuration]

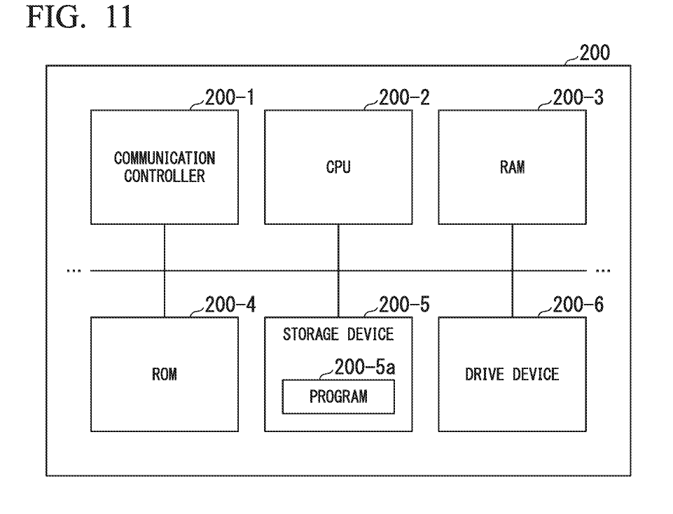

The vehicle support device 200 of the embodiment described above is realized by, for example, a hardware configuration as illustrated in FIG. 11. FIG. 11 is a diagram showing an example of a hardware configuration of the vehicle support device 200 according to the embodiment.

The vehicle support device 200 has a configuration in which a communication controller 200-1, a CPU 200-2, a RAM 200-3, a ROM 200-4, a secondary storage device 200-5 such as a flash memory or an HDD, and a drive device 200-6 are connected to each other by an internal bus or a dedicated communication line. A portable storage medium such as an optical disc is attached to the drive device 200-6. A program 200-5a stored in the secondary storage device 200-5 is developed in the RAM 200-3 by a DMA controller (not illustrated) or the like and executed by the CPU 200-2, thereby realizing functional units of the vehicle support device 200. A program referred to by the CPU 200-2 may be stored in a portable storage medium mounted on the drive device 200-6 or may be downloaded from another device via the network NW.

The above embodiment can be represented as follows.

The vehicle support device includes a power generation unit including an internal combustion engine that outputs a motive power to be used by an electric motor and the electric motor that generates power using the motive power output by the internal combustion engine, a power storage battery that stores the power generated by the power generation unit or a power supplied at an energy replenishment point, and an electric motor for traveling that is connected to driving wheels of a vehicle and driven using the power supplied from the power storage battery to rotate the driving wheels, a storage device, and a hardware processor that executes a program stored in the storage device, wherein the hardware processor executes the program to thereby estimate an energy replenishment point on the basis of the number of times of use or a frequency of use of each energy replenishment point at which a power was stored in a power storage battery of a vehicle in the past, and information on the estimated energy replenishment point is provided to the vehicle.

Although a mode for carrying out the present invention has been described above using the embodiment, the present invention is not at all limited to the embodiment, and various modifications and substitutions may be made without departing from the spirit of the present invention.

What is claimed is:

1. A vehicle support device comprising:
an estimation unit that estimates an energy replenishment point on the basis of the number of times of use or a frequency of use of each energy replenishment point at which a power was stored in a power storage battery of a vehicle in the past, the vehicle including a power generation unit including an internal combustion engine that outputs a motive power to be used by an electric motor, and the electric motor that generates a power using the motive power output by the internal combustion engine, the power storage battery that stores the power generated by the power generation unit or a power supplied at the energy replenishment point, an electric motor for traveling that is connected to driving wheels of the vehicle and driven using the power supplied from the power storage battery to rotate the driving wheels; and
an information providing unit that provides information on the energy replenishment point estimated by the estimation unit.

2. The vehicle support device according to claim 1, further comprising:
a learning unit that learns the number of times of use or the frequency of use of each energy replenishment point at which the power was stored in the power storage battery in the past,
wherein the learning unit learns the number of times of use or the frequency of use for each route from a departure point to an arrival point when the vehicle has used the energy replenishment point.

3. The vehicle support device according to claim 2, wherein the estimation unit estimates a future traveling route of the vehicle among routes learned by the learning unit on the basis of an environmental situation when the energy replenishment point has been used.

4. The vehicle support device according to claim 2, further comprising:
a specifying unit that specifies an occupant of the vehicle,
wherein the learning unit learns the number of times of use or the frequency of use of each energy replenishment point for each occupant specified by the specifying unit.

5. The vehicle support device according to claim 4, wherein the estimation unit estimates, for each occupant specified by the specifying unit, an energy replenishment point predicted to be used by the occupant.

6. The vehicle support device according to claim 1, wherein the estimation unit estimates the energy replenishment point on the basis of the number of times of use or the frequency of use of each energy replenishment point at which the power was stored in the power storage battery in the past in a case that the vehicle is estimated to travel a predetermined distance or more.

7. A vehicle control method that is executed by a computer mounted in a vehicle, the vehicle control method comprising:
estimating an energy replenishment point on the basis of the number of times of use or a frequency of use of each energy replenishment point at which a power was stored in a power storage battery of a vehicle in the past, the vehicle including a power generation unit including an internal combustion engine that outputs a motive power to be used by an electric motor, and the electric motor that generates a power using the motive power output by the internal combustion engine, the power storage battery that stores the power generated by the power generation unit or a power supplied at the energy replenishment point, an electric motor for traveling that is connected to driving wheels of the vehicle and driven using the power supplied from the power storage battery to rotate the driving wheels; and
providing information on the estimated energy replenishment point to the vehicle.

8. A computer-readable non-transitory storage medium storing a program, the program causing a computer to:
estimate an energy replenishment point on the basis of the number of times of use or a frequency of use of each energy replenishment point at which a power was stored in a power storage battery of a vehicle in the past, the vehicle including a power generation unit including an internal combustion engine that outputs a motive power to be used by an electric motor, and the electric motor that generates a power using the motive power output by the internal combustion engine, the power storage battery that stores the power generated by the power generation unit or a power supplied at the energy replenishment point, an electric motor for traveling that is connected to driving wheels of the vehicle and driven using the power supplied from the power storage battery to rotate the driving wheels; and
provide information on the estimated energy replenishment point to the vehicle.
